(19) United States
(12) Patent Application Publication
(10) Pub. No.: US 2020/0102233 A1
(43) Pub. Date: Apr. 2, 2020

(54) WASTEWATER TREATMENT SYSTEM AND METHOD

(71) Applicants: Steven White, Corvallis, OR (US); Ganti Suryanarayana Murthy, Corvallis, OR (US)

(72) Inventors: Steven White, Corvallis, OR (US); Ganti Suryanarayana Murthy, Corvallis, OR (US)

(73) Assignee: Oregon State University

(21) Appl. No.: 16/583,656

(22) Filed: Sep. 26, 2019

Related U.S. Application Data
(60) Provisional application No. 62/738,806, filed on Sep. 28, 2018.

(51) Int. Cl. C02F 1/52; C02F 9/00

(52) U.S. Cl. CPC C02F 1/5245; C02F 2101/16; C02F 9/00

(57) ABSTRACT

Disclosed herein are embodiments of a method for treating contaminated water, such as leachate from landfills. The method may comprise treating the water with a coagulant, such as an iron salt, then treating the resultant partially treated water with a hydroxide salt, such as lime soda, and finally removing ammonia. The resulting treated water stream is suitable for incorporation into further wastewater treatment processes, such as processes that use biological treatments or land application in agricultural fields.

### CROSS REFERENCE TO RELATED APPLICATION

This application claims the benefit of the earlier filing date of U.S. provisional patent application No. 62/738,806, filed on Sep. 28, 2018, which is incorporated herein by reference in its entirety.

### FIELD

Certain embodiments concern a method for water treatment comprising a coagulant, such as an iron salt, hydroxide addition and ammonia removal.

### BACKGROUND

Leachate from municipal solid waste landfills is a significant threat to the quality of surface- and groundwater. Treating landfill leachate is a major problem for both the municipal solid waste landfills that generate the leachate, and also the wastewater treatment plants (WWTPs) that treat the leachate. Landfill leachate (LL) can contain hundreds of organic compounds, contaminants of emerging concern (CECs), toxic metals, and/or toxic inorganic compounds, such as ammonia. Most landfills are considered stable and generate large quantities of both ammonia and methane gas. Due to recent consolidation of landfills, the number of active landfills in the United States has been reduced from >10,000 to <2,000. As the population increases, the total annual disposal of municipal solid waste that a single landfill stores also increases. Thus, treating the resulting landfill leachate is an increasing problem.

A common practice in controlling leachate generation is to control the quantity of water entering the landfill through waste compaction, which can reduce infiltration rates. Landfill leachate compositions can differ depending on the type of municipal solid waste stored, the weather, the season, and amount of time the waste is stored in the landfill body. As these parameters vary within the landfill, the diversity and amount of organic and inorganic contaminants and dissolved metals vary in the leachate. However, the leachate composition from landfills that receive more than 10 inches of rainfall per year typically varies only in the strength of the pollutants.

The composition of the landfill leachate plays an important role in selecting the appropriate wastewater treatment technology. Typically, all landfill leachates comprise CECs, ammonia, and toxic metals in varying concentrations. The amount or volume of landfill leachate also plays an important role in wastewater treatment selection. For low volume landfill leachate, leachate and other wastewater influent may be treated in an aerobic/anoxic lagoon. However, the vast majority of landfill leachate is treated by local WWTPs by diluting the leachate into the influent stream of the WWTPs. This stream usually comprises storm runoff and household wastewater. And for leachate with high ammonia levels, biological treatment is not possible unless the leachate is diluted, such as with residential wastewater, prior to treatment by the WWTPs.

High concentrations of nitrogen are known to be hazardous to fisheries, public health and economies, and therefore need to be removed from receiving waters prior to discharge. For example, ammonia and nitrates can cause eutrophication of surface water, and elevated nitrogen levels also can destroy the microbial population present in the activated sludge of wastewater treatment plants. Nitrogen removal is generally achieved through biological nitrification-denitrification processes for young leachate and through physical-chemical processes in stabilized leachate. Typically, ammonia is easily denitrified to nitrate but WWTPs often have a difficulty in removing the resulting nitrate. Nitrification is a much slower anoxic/anaerobic reaction. Therefore, in leachate having a high ammonia load, a biological treatment may not be feasible. And denitrification is a process that is typically orders of magnitude slower than nitrification. Natural leachate treatment systems include leachate recirculation in landfill bioreactors and the use of reed beds for polishing treated effluent. Typically, if the ammonia is less than 150-200 ppm, the leachate can be treated with a lagoon, but this is only feasible if the ammonia and volume are low. For most of the municipal solid waste (MSW) landfills in the U.S., the landfill leachate is diluted such that the ammonia is less than 200 ppm. And the nitrate generated is poorly or not removed.

Another common method of treating municipal wastewater combines biological, physical and chemical treatment processes. For example, the majority of WWTPs treat residential and storm waters with a series of aerobic/anoxic basins followed by physical/chemical treatment processes. However, these common treatment processes are ineffective in removing the CECs, toxic metals, nor high ammonia contaminants from the environment.

Traditionally, landfill leachate has been hauled or pumped to off-site wastewater treatment facilities for disposal. For example, a landfill that generates leachate typically requires about 142 tanker runs per million gallons of generated leachate. A medium size landfill will generate 20M-100M gallons per year, resulting in from 2,000 to 15,000 tanker runs. This means an average of 10 to 50 runs per day. Additionally, increasingly stringent effluent discharge requirements have resulted in opposition to leachate disposal in off-site treatment plants from the plant owners. Furthermore, there is a significant risk of damage to, or inactivation of, the activated sludge that is used for in aerobic/anoxic digesters. Such damage can result in large fines from the state and EPA due to the discharge of pollutants into surface water. And WWTPs typically are not designed to handle the complexity of the leachate. Researchers have found CECs both in the outflow from WWTPs and in the bio sludge used as fertilizer in agricultural applications. And in addition to the organics, most of the toxic transitional metals complex with the biosolids and were found in the soil and ground water. (Masoner et al. (2016) Landfill leachate as a mirror of today's disposable society: Pharmaceuticals and other contaminants of emerging concern in final leachate from landfills in the conterminous United States. Environmental Toxicology and Chemistry, Vol. 35(4), pp 906-918; Kinney et al. (2006) Survey of organic wastewater contaminants in biosolids destined for land applications. Environmental Science and Technology, Vol. 40(23), pp. 7207-7215, both incorporated herein by reference.)

When discharged to a wastewater treatment facility, landfill leachates also can interfere with ultraviolet disinfection by strongly quenching UV light. Leachate may also contain heavy metals and high ammonia concentration that may be inhibitory to the biological processes. Biological leachate treatment is a proven technology for some organics and limited ammonia removal in young and mature leachate. The anoxic/aerobic processes achieve nitrification and denitrification and reduce the oxygen demand for landfill leachate treatment. The aerobic/anoxic processes can nitrify the ammonia in wastewater stream if the ammonia concentration is <200 ppm, but for most landfills that have been active for more than 10 years, the ammonia concentration can vary from 400 to 3500 ppm or more, which can significantly impact any downstream biological treatment. And for most of the WWTPs the denitrification process is ineffective in removing the nitrate completely. Biological treatment methods that have been tried to treat landfill leachate include the activated sludge process (ASP), sequencing batch reactors (SBR), membrane bioreactors (MBR), aerobic lagoons, and constructed wetlands. However, while these treatments may provide some benefit for small private landfills that produce minimal to small amounts of low-contaminant leachate, these treatments have largely been unsuccessful for municipal landfills. Physical-chemical treatment methods include oxidation, coagulation/flocculation, activated carbon, stripping, evaporation, filtration and reverse osmosis (RO).

The choice of wastewater treatment technology depends largely upon characteristics of the leachate and discharge limitations. Leachate is characterized by high chemical oxygen demand (COD) (1,000-20,000 or more mg/l), ammonia (150-3600 or more mg/1), total dissolved solids (TDS) (2,000-15,000 or more mg/l) and intense color (up to 2,000 Pt—Co). Hydraulic retention time (HRT) must be of sufficient duration to provide for hydrolysis of slowly biodegradable compounds in the leachate and to achieve low enough organics, prior to aerobic nitrification, such as BOD <5 mg/l, ammonia <3 mg/l, and total phosphorus (TP)<0.5 mg/l, which are all below the compliance criteria of 5 mg/l, 3-5 mg/l, and 0.5 mg/l, respectively. Many of the organic compounds are recalcitrant, in that they not easily degraded and certainly not degraded by the microbial diversity in the aerobic and anoxic digesters in the WWTPs. The average effluent total suspended solids (TSS) concentration may range from 4-11 mg/l which is below the regulatory requirement of 15 mg/l that is set by the EPA for surface discharge. However, if the leachate is treated onsite, the permit to discharge over land may be regulated by the state and the limits may not be a stringent as the ones set by the EPA.

In order to achieve stable operation despite highly variable carbon-to-nitrogen ratio, the overall leachate treatment facility (LTF) was designed for extended retention time of 2.3 days (anoxic and aerobic HRTs of 15 and 40 hours, respectively). Methanol and phosphoric acid are added as carbon and phosphorus sources. Specific leachate management practices, such as recirculation (bioreactor landfill) impact quality for ammonia concentrations under 200 ppm, resulting in characteristics that vary greatly from site to site. Extreme temperatures, such as cold temperatures in winter in northern latitudes for example in Canada, also are a challenge to designing LTFs, because the extreme heat or cold can affect microbial degradation efficiency. See, for example, Mark Greene, Ph.D., P.E. OBG and Anne Reichert, P.E. WM, Landfill Leachate Overview, 18th Annual New England Pretreatment Coordinators Workshop (Oct. 27, 2016).

### SUMMARY

In view of the above, there is a need for a water treatment system and method that can process wastewater, such as landfill leachate, to produce a water stream suitable for direct surface discharge/use for land application in agricultural fields and/or for further water treatment processes, such as vertical-flow constructed wetlands. Disclosed herein are embodiments of a method for treating contaminated water, such as a leachate from waste and/or landfill sites, and optionally may comprise recovering and/or isolating valuable metals, important organic matter, and ammonium salts suitable for use as a fertilizer. Certain embodiments concern a novel integrated water treatment system and method that can treat the wastewater reproducibly and effectively to produce a quality water stream suitable for direct surface discharge/use for agricultural applications and is not limited by high ammonia concentrations or other contaminants in the wastewater. In some embodiments, the method comprises combining wastewater, such as landfill leachate, and a coagulant, such as an organic salt, inorganic salt, or a combination thereof, to form a first mixture comprising a first solid formed from the coagulant and organic matter present in the wastewater, and separating the first solid from the first mixture to form a first liquid. The coagulant may be a metal salt, such as an iron salt, for example, a ferric salt, such as ferric chloride. The first liquid is then combined with one or more hydroxide salts, optionally comprising calcium hydroxide, to form a second mixture comprising a second solid formed from the one or more hydroxide salts and at least a portion of any dissolved metal ions. The second solid is separated from the second mixture to form a second liquid. The second liquid is then formed into droplets that are exposed to an air flow sufficient to remove at least a portion of ammonia present in the droplets. In some embodiments, a large fraction of the ammonia is removed. In certain embodiments, substantially all of the ammonia is removed and/or the portion of ammonia removed is sufficient that the amount of any residual ammonia is below a maximum allowable limit for surface application of the water and/or reuse.

The droplets may be collected after exposure to the air flow to form a treated water stream suitable for further water treatment processing, such as by agricultural surface application and/or discharge or reuse. And/or the ammonia may be collected with a scrubbing solution, such as an acidic scrubbing solution, that may be recycled and/or reused until a concentration of ammonia in the scrubbing solution is above 50% saturation, or approximately 4.3 moles/liter or 550 mg ammonium salt/liter. And/or the scrubbing solution may be dried or allowed to dry to form an ammonium salt, such as ammonium sulfate crystals or solids, that may be suitable for use as a fertilizer and/or other applications.

In some embodiments, combining the first liquid with the one or more hydroxide salts to form the second mixture and separating the second mixture to form the second liquid comprises combining the first liquid with an amount of a first hydroxide salt to form a first intermediate mixture comprising a first intermediate solid and separating the first intermediate solid from the first intermediate mixture to form a first intermediate liquid. The method may further comprise adding an amount of a second hydroxide salt to the first intermediate liquid to form a second intermediate mixture comprising a second intermediate solid, and separating the second intermediate solid from the second intermediate mixture to form a second intermediate liquid. The second hydroxide salt may be the same as or different from the first hydroxide salt. And an amount of a third hydroxide salt, which may be the same as or different from either the first and/or second hydroxide salts, may subsequently be added to the second intermediate liquid to form a third intermediate mixture comprising a third intermediate solid. The third intermediate solid is then separated from the third intermediate mixture to form the second liquid. The amount of the first hydroxide salt may be selected to provide a pH for the first intermediate mixture of 8.5 or less, the amount of the second hydroxide salt may be selected to provide a pH for the second intermediate mixture of 9.5 or less, and/or the amount of the third hydroxide salt may be selected to provide a pH for the third intermediate mixture of 10.3 or less.

In some embodiments, the one or more hydroxide salts, such as the first hydroxide salt, the second hydroxide salt and the third hydroxide salt, comprise, consist essentially of, or consist of, calcium hydroxide, and/or in certain embodiments, the first hydroxide salt, the second hydroxide salt and the third hydroxide salt are all the same.

In any embodiments, forming the droplets may comprise flowing the second liquid through at least one nozzle at a pressure suitable to form the droplets. The pressure may be from 100 psi to 300 psi, and/or the droplets may have a droplet size of from 10 micrometers to 1,000 micrometers, such as from 10 micrometers to 500 micrometers, or from 50 micrometers to 100 micrometers.

In some embodiments, the coagulant, such as an iron salt, is added to the wastewater, such as a leachate, in an amount sufficient to remove at least 80%, such as at least 85%, 90% or 95%, of any acidic organic matter present in the wastewater. The one or more hydroxide salts, such as calcium hydroxide, may be added to the first liquid in an amount sufficient to remove at least 80%, such as at least 85%, 90% or 95%, of any metal ion impurities present in the first liquid. And/or forming the droplets and exposing them to the air flow may remove at least 80%, such as at least 85%, 90% or 95%, of any ammonia present in the second liquid.

Also disclosed herein is a system for treating wastewater, such as landfill leachate. The system may comprise a wastewater pathway, comprising a wastewater inlet, an organics separator module, a metal recovery module, and/or an ammonia recovery module. The organics separator module may comprise a coagulant inlet downstream from the wastewater inlet, a reactor downstream of the coagulant inlet, and a first separator downstream of the reactor. The first separator may comprise a first solids outlet and a first liquid outlet.

The metal recovery module may comprise a first water flow pathway fluidly coupled to the first liquid outlet and comprising a first hydroxide salt inlet and a second separator fluidly coupled to the first water flow pathway downstream from the first hydroxide salt inlet. The second separator may comprise a second solids outlet and a second liquid outlet. The module may also comprise a second water flow pathway fluidly coupled to the second liquid outlet and comprising a second hydroxide salt inlet and a third separator fluidly coupled to the second water flow pathway downstream from the second hydroxide salt inlet. The third separator may comprise a third solids outlet and a third liquid outlet. Additionally, the module may comprise a third water flow pathway fluidly coupled to the third liquid outlet and comprising a third hydroxide salt inlet and a fourth separator fluidly coupled to the third water flow pathway downstream from the third hydroxide salt inlet, where the fourth separator comprises a fourth solids outlet and a fourth liquid outlet.

The ammonia recovery module may comprise an ammonia separator fluidly coupled to the fourth liquid outlet, the ammonia separator comprising at least one nozzle that forms droplets from a fluid stream received from the fourth liquid outlet, and a blower configured to produce an air flow counter to a direction of motion of the droplets formed by the nozzle. The ammonia separator may be fluidly connected to an ammonia scrubber that removes ammonia from the air flow.

In any embodiments, the first separator, the second separator, the third separator and/or the fourth separator independently may be a clarifier, such as a baffled rectangular clarifier, a circular-lamella clarifier, or a plate and frame filter press.

The foregoing and other objects, features, and advantages of the invention will become more apparent from the following detailed description, which proceeds with reference to the accompanying figures.

### BRIEF DESCRIPTION OF THE DRAWINGS

FIG. 1 is a process flowchart illustrating an exemplary embodiment of the disclosed technology.

FIG. 2 is a process flowchart illustrating another exemplary embodiment of the disclosed technology.

FIG. 3 is a schematic diagram illustrating an exemplary rectangular clarifier in accordance with some embodiments of the disclosed technology.

FIG. 4 is a schematic diagram illustrating an exemplary pipe layout designed to maintain turbulent flow for a specified period of time in accordance with certain embodiments of the disclosed technology.

FIG. 5 provides the cross-section profile of the pipe layout illustrated in FIG. 4 along the line A-A′.

FIG. 6 is a graph of floc weight versus ferric salt concentration, illustrating how the floc weight varies as a function of ferric salt concentration.

FIG. 7 is a graph of chemical oxygen demand (COD) versus ferric salt concentration, illustrating how the COD varies as a function of ferric salt concentration.

FIG. 8 is a graph of diameter of feed pipe versus million gallons of leachate per year, illustrating the effect of leachate volume and the diameter of the pipe based on a Reynolds number of 8,000 for turbulent mixing.

FIG. 9 is graph of cross-sectional area of the feed pipe versus million gallons of leachate generated per year, illustrating the effect of leachate volume and the cross-sectional area of the pipe based on a Reynolds number of 8,000 for turbulent mixing.

FIG. 10 is a graph of pH versus volume of calcium hydroxide, illustrating how the pH increases more slowly with the addition of calcium hydroxide in liquids containing metal ions than in water without metal ions.

FIG. 11 is a schematic diagram illustrating exemplary piping suitable for automated addition of Ca(OH)₂ to the partially clarified leachate feed.

FIG. 12 is a schematic diagram illustrating one example of the ammonia stripping and absorption step of the system, in accordance with some embodiments of the disclosed technology.

FIG. 13 is a graph of dry sludge weight versus pH, illustrating the amounts of dry sludge that was recovered from the leachate by addition of ferric chloride at different pHs.

FIG. 14 is a graph of weight of floc formed versus concentration of ferric chloride, illustrating the amount of floc formed at pH 8 by the addition of various concentrations of ferric chloride.

FIG. 15 is a graph of dry weight of floc versus pH, illustrating how the amount of floc that is formed and recovered varies with pH.

### DETAILED DESCRIPTION

### I. Definitions

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximations unless the word “about” is recited.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

“Chemical Oxygen Demand” or COD refers to a measurement of the oxygen required to oxidize soluble and particulate organic matter in water.

“Biochemical Oxygen Demand” (BOD, or Biological Oxygen Demand) is the amount of dissolved oxygen needed by aerobic biological organisms to break down organic material present in the water. The BOD value may be expressed in milligrams of oxygen consumed per liter of sample during 5 days of incubation at 20° C.

“Coagulant” refers to an agent that modifies the chemistry of a colloidal-organic suspension or fatty acid allowing the moieties to aggregate and form large, dense particles. These particles are easily separated based on Stoke's law (Equation 1)

$${V}_{S} = \frac{2 g {r}^{2} ( {ρ}_{p} - {ρ}_{l} )}{9 η} \qquad Equation 1$$

where V=final velocity of particle, r=radius of particle, ρₚ=density of particle, ρₗ=density of liquid, η=coefficient of viscosity, g=gravitational constant.

“Floc” refers to the solid particle formed from the organic matter and coagulant.

“Solids” as used herein with respect to impurities present in water, refers to any impurities present in the water (e.g. ammonia, carbon dioxide, oils, metal ions etc.), regardless of their typical physical state at room temperature and pressure when isolated from the water.

### II. Overview

This disclosure concerns a continuous integrated system and method that recovers impurities, such as organics, metals, and ammonium salts, from a wastewater stream and produces a treated water stream suitable for reuse and/or discharge into the environment or agriculture. The wastewater stream may be any wastewater stream, such as a water stream originating from a Municipal Solid Waste (MSW) disposal site. The disclosed technology produces several valuable products, such as organics, including oils; metals; nitrogen compounds, such as ammonia; and/or water. The products may be produced in a form suitable for reuse, such as suitable for direct agricultural applications and suitable for human consumption after Reverse Osmosis treatment. For human consumption, the treated water must meet water quality specifications set by EPA and state regulatory guidelines. The disclosed technology focuses not only on the removal of the pollutants, but on the recovery of valuable resources, such as oils, metals, and ammonia fertilizer. By continually characterizing the properties of the wastewater stream, such as landfill leachate, the system can be adjusted during the operation. The system is designed with three primary modules: 1) organic recovery; 2) metals recovery; and 3) nitrogen compound/ammonia recovery components. The individual modules are capable of being easily expanded or reduced in the size and scope of operation in-situ to meet the seasonal variability of the wastewater volume and composition. This minimizes wasteful use of both energy and resources during yearly operation. The disclosed technology can recover more than 95% of the total solids from the wastewater, such as, but not limited to, oils, ammonia, and/or transitional metals. Embodiments of the disclosed technology may have one or more of the following advantages over conventional methods:
able to adjust easily to the seasonal changes in rainfall;
not dependent on the climate, and thus able to operate year-round without a decrease in performance;
requires no equalization basin to buffer high flow events;
can easily be placed at the landfill and easily moved as the landfill expands;
it has a small footprint;
able to remove more than 95% of the total suspended and dissolved solids; and
able to produce a treated water stream suitable for reuse or discharge.

### III. Description

Described herein are specific unit operations and methods for the removal of contaminants and recovery of resources from a wastewater stream. In one exemplary embodiment, the wastewater stream originates from a solid waste landfill, described as landfill leachate (LL) throughout. Each unit operation is designed to remove and recover specific components present in the LL, including organic compounds which may be combusted to produce energy, converted to oils and biodiesel, and/or dried and used to supplement soils for sorption of organic pollutants; dissolved metals, which may be recovered as high-quality ore-grade materials; and nitrogen compounds, including ammonia, which may be recovered for use as fertilizer.

The system and method can be adjusted to optimally recover energy, metal, and fertilizer resources from a variety of LL streams, and may comprise the steps of:
1. Recovering organics through flocculation with organic or inorganic salts, such as modified starches or iron salts, for example, ferric salts, such as ferric chloride;
2. Recovering dissolved metals through hydroxide-induced precipitation of solids; and
3. Nitrogen removal through ammonia stripping and absorption.
   In some embodiments, metal salts that can be used as a coagulant in step 1 are recycled, thereby reducing the demand for metal salts, such as ferric chloride, and the amount of dissolved solids that have to be removed.

However, in alternative embodiments, the step of recovering organics through flocculation, recovery of metals and/or ammonia stripping may be omitted. The modules can work independently from each other, and if a module is used independently, one or both of the other modules can be added as needed. Conversely, any one or more of the modules can be removed from the system as the landfill matures and reaches closure, depending on the requirements at any particular time.

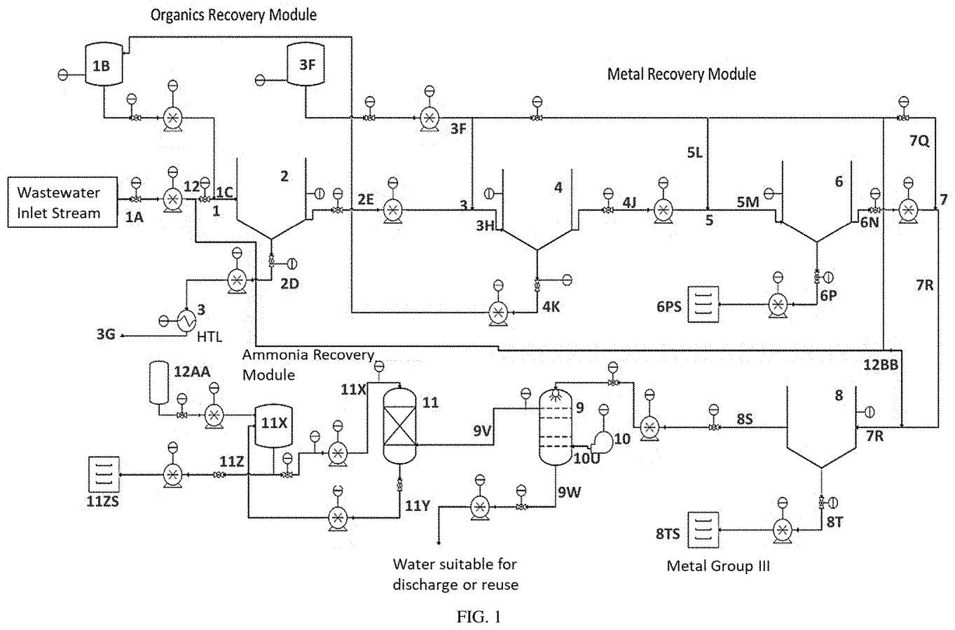

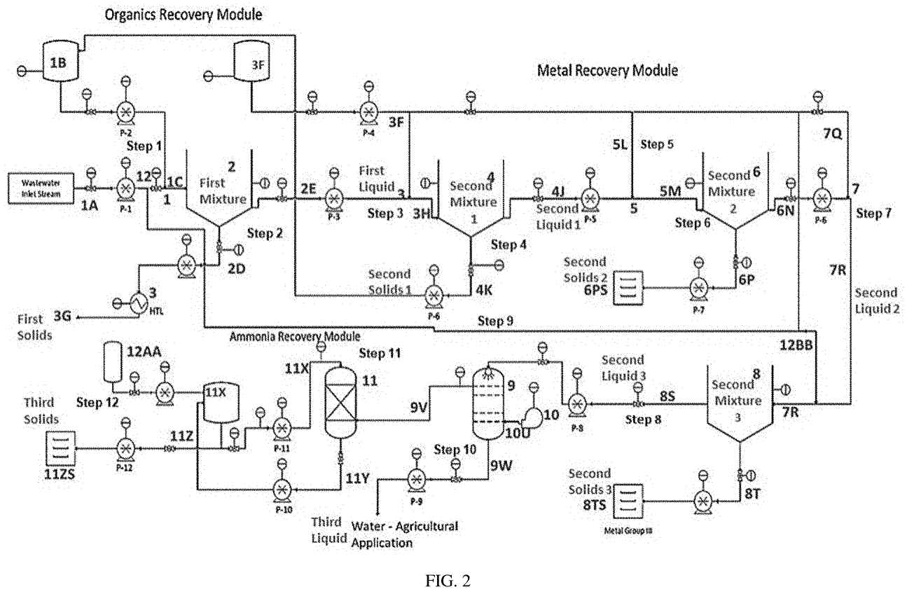

Typically, the principle contaminants of LL are organic-colloidal suspensions (fulvic, humic, and other organic metabolic by products), metals (such as, but not limited to, cadmium, chromium, arsenic, and/or transition metals), inorganic compounds (ammonia), xenobiotics, (halogenated aliphatic compounds, PAHs, PCBs, and petroleum-based aromatics), and each requiring a separate treatment strategy that focuses on each of their specific chemistries. The technology described herein addresses each of the chemistries in each of the separate unit operations. Exemplary embodiments of the system are illustrated in FIGS. 1 and 2.

A. Organics Removal

Referring to FIGS. 1 and 2, the raw wastewater influent stream (1A) is dosed in-line with a measured amount of a coagulant (1B). The coagulant may be an organic and/or inorganic salt, such as a modified starch and/or an iron salt coagulant, for example, a ferric salt such as ferric chloride. The coagulant may be directly added into an active-turbulent flow of the influent wastewater stream (1A) thereby forming a complex, such as an iron-organic complex (1C). Certain design features and/or dimensions of the coagulation system (1) may be advantageous for effective coagulation of the coagulant-organic complex. Advantageous design features may include the diameter of the pipe in relation to the fluid velocity within the pipe, inline mixer(s) creating or increasing turbulence in the liquid, the length of the total piping, the point of coagulate injection, the concentration of the chemical modifier, the outlet diameter with the solid/liquid separator that facilitates laminar flow, and/or the size and location baffles to retard flow of the suspended solids within the tank at the point of inlet piping. Certain embodiments comprise an injection nozzle that introduces the coagulant into the pipe containing the wastewater stream, the diameter of the pipe and/or the action of the nozzle facilitating a turbulent flow of the coagulant and wastewater, thereby facilitating mixing. The pipe may subsequently widen to facilitate laminar flow to allow for the coagulated fatty acids to increase in size. Exemplary design parameters for the pipe length and diameter may be: residence time in pipe >20 sec, Reynold's number (Re) >5000 in pipe, Re <10 pipe opening in tank. The diameter and height of tank may be a function of the settling velocity. Suitable solid/liquid separators include, but are not limited to, a sedimentation tank and/or a suitable sized plate and frame filter press, where the size of the filter press may be determined by the location specific leachate characteristics, expected treatment volumes and peak flow rates, desired maintenance schedules and commercially available filter press sizes.

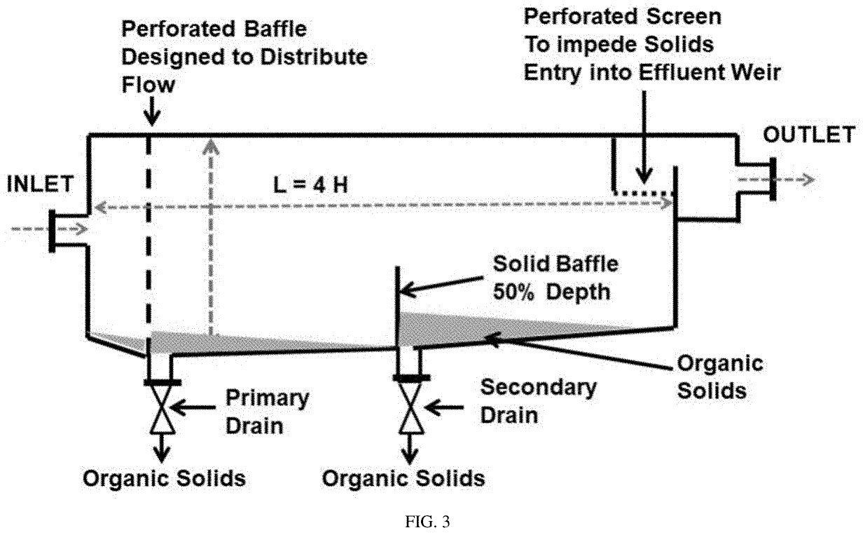

The solid-organic complexes (2D) are separated from the treated wastewater stream (1C) in a suitable separator (2), such as a clarifier. FIG. 3 provides a schematic diagram of an exemplary clarifier suitable for use with the disclosed technology, and further exemplary clarifiers include, but are not limited to, a baffled rectangular clarifier, a circular-lamella clarifier, or other clarifier architectures as are familiar to a person of ordinary skill in the art, such as a plate and frame filter press. The technology is designed to continuously separate the solids (2D) and liquid streams (2E). The solids stream (2D) is optionally directed to a hydro-thermal liquefaction system (HTL) (3) that converts the organic-complexes (2D) into valuable oils (3G). In a hydrothermal liquefaction system, the organic solids stream may be heated to from 300° C. or less to 350° C. or more, such as from 300° C. to 350° C., from 300° C. to 325° C., and in some embodiments, at 310° C., for a suitable time period, such as from greater than zero to 60 minutes or more, from 5 to 60 minutes, from 5 to 30 minutes, and in some embodiments, for 15 minutes. The heating may be performed under a suitable pressure, such as from 150 bar or less to 300 bar or more, from 175 bar to 250 bar, and in some embodiments at 200 bar. The process converts the organic fraction into a gas that may comprise one or more of CO₂, CO and trace hydrogen; biocrude, which is a crude oil-like fraction that can be used in petroleum refineries after upgradation to reduce the oxygen concentration from 15-20% w/w to 2-3% w/w; and hydrochar, which is a type of carbon-rich water insoluble residual material which is similar to biochar. The yields of gas, biocrude and hydrochar can be varied by controlling the operating conditions (such as residence time, temperature and/or reactor pressure). Typical yields of these three fractions are 30-40% hydrochar, 40-55% biocrude and remaining fraction is the gas.

The initial target contaminant (OM-organic matter) is removed from the raw LL feed stream (1A) with the aid of a coagulant (1B) that complex with the organic matter allowing the organic matter to form large particles or “flocs”. Suitable coagulants include, but are not limited to, modified starches, and organic and/or inorganic salts, such as iron salts (for example ferric salts, including ferric chloride), and potassium salts (such as a potassium salt of aluminum sulfate KAl(SO₄)₂ (alum)). The process of charge neutralization and bonding of particles to form “micro-floc” particles is called coagulation. The coagulant is fed directly into the inlet piping at a rate that maintains the desired concentration and pH for particle formation. In some embodiments, the pH is from 5 to 8. The pH may be maintained in the desired range by addition of acid or base as requires, such as a mineral acid, for example, hydrochloric acid, or a hydroxide base, such as calcium hydroxide. In some embodiments, the flow rate of the leachate is from greater than zero to 4 gallons/minute or more, such as from 1 gal/min to 3 gal/min. In other embodiments, the flow rate of the coagulant is from 1/50 to 1/200 of the leachate flow rate, such as from 1/75 to 1/150 of the leachate flow rate. In certain embodiments, the flow rate of the leachate is about 2 gal/min and/or the flow rate of the coagulant is about 1/100 of the leachate flow rate. The pipe diameter may be selected depending on the Reynold's number and the desired volumetric output. In some embodiments, the diameter of the piping is selected such that the flow is turbulent (e.g. a high Reynold's number >5,000), and/or the mixing is enhanced with a series of flow restrictors that ensure turbulent flow.

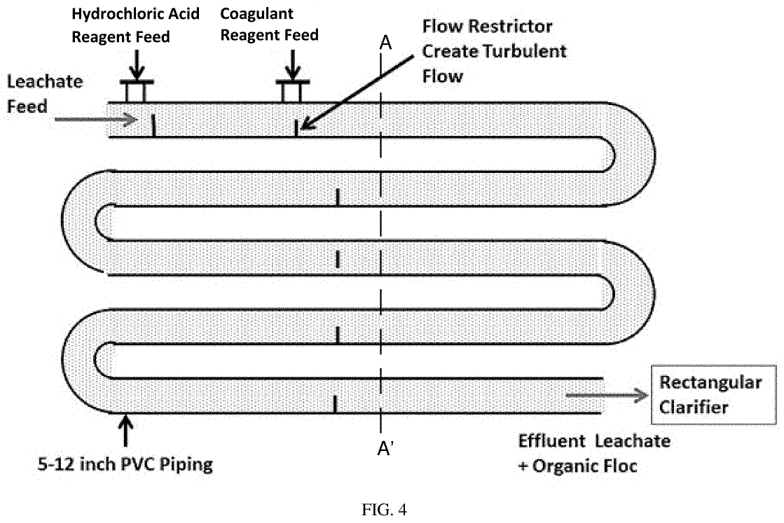

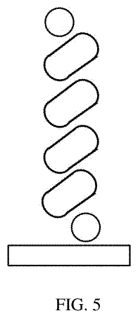

Reynold's number is defined as:

$$Re = \frac{ρ {uD}_{H}}{η} = \frac{{uD}_{H}}{v} = \frac{{QD}_{H}}{vA} \qquad Equation 2$$

where Re=Reynolds number, ρ=fluid density in the pipe, u=the velocity of the fluid in the pipe, D_{H}=hydraulic diameter of the pipe, η=dynamic viscosity of the fluid in pipe, v=kinematic viscosity of the fluid in the pipe, Q=the volumetric flow rate of the fluid in the pipe, and A=the cross-sectional area of the pipe. The length of pipe is designed such that turbulent flow is maintained for a period of 10-20 seconds in the pipe (FIG. 4). In some embodiments, the length of pipe is from 1 meter or less to 20 meters or more. A cross section of the pipe is illustrated in FIG. 5, the cross section being where the dashed line is shown in FIG. 4. In certain embodiments, the pipe diameter is from 5 to 12 inches.

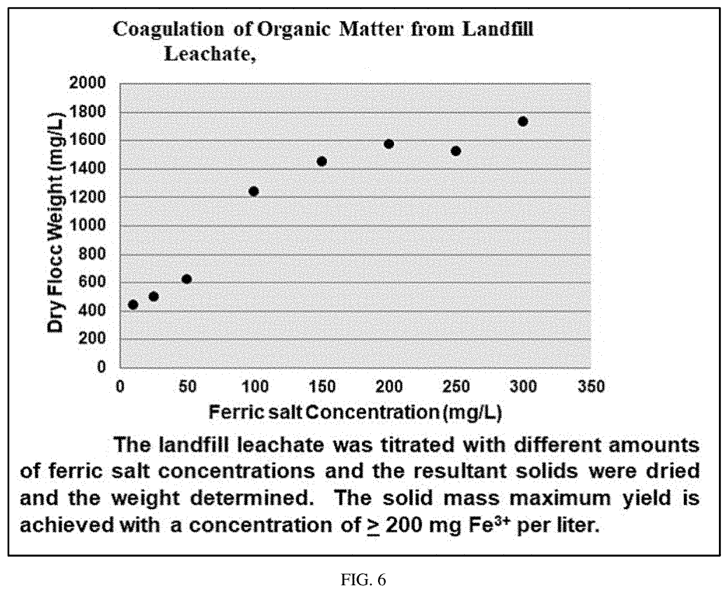

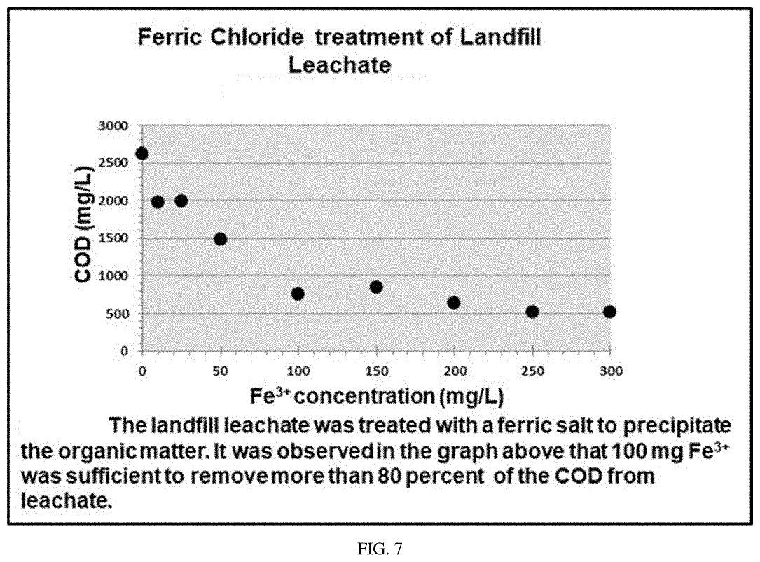

To demonstrate the effectiveness of one example embodiment of the system, extensive sampling identified regions of removal based on initial concentration of OM, coagulant dosage, and pH conditions (FIG. 6 and FIG. 7). In some embodiments, the amount of coagulant used was from 30 mg to 3,000 mgs per gallon of leachate. Charge neutralization of principally fatty acids, humic and fluvic acids generated in the landfill by decomposition of paper and wood products, was achieved by the titration of the inlet waste-stream (A) with hydrochloric acid to obtain a pH of from 5 to 8, such as from 5 to 6. The ferric salt then interacts with the organic matter in a way that reduces the intermolecular repulsive forces and stabilizing the particle formation.

The final concentration and pH of the metal salts, such as ferric chloride in the waste stream can be determined by performing laboratory tests on the LL with different concentrations of iron salts and pH. A particle size for the “floc” of greater than 1000 micrometers is advantageous to obtaining clean separation of liquid and solids and percent organic matter removal after the “floc” formation. Excessive shear or mechanical action can tear apart a “floc”. While distribution of the “floc” in the lamella clarifier inlet basin is essential, overmixing is detrimental due to floc shear. Therefore, the clarifier (2) inlet basin is designed to reduce the Re of the inlet stream by increasing the cross-sectional area of the inlet piping perpendicular to flow to a value determined empirically based on the feed rate. In some embodiments, the horizontal clarifier may be replaced by a plate and frame filter press that can be used to minimize the footprint and cost of operation.

The organic solids are collected at the bottom of the clarifier (2) by gravity. The bottom drain value controls the flow rate of the organic solids such that the total flow in equals the total flow out of the lamella clarifier (2), or the plate and frame filter press, if present. The organic solids (2D) are approximately 10% by volume of the inlet stream (1C). The solids are passed through the HTL (3) to produce oils (3G). The liquid (2E) is treated with Ca(OH)₂ to remove metals. In embodiments comprising a plate and frame filter press, the volume of the solids may be reduced in the filter press as well as a reduction of water content of the solids.

B. Metals Recovery

The liquid effluent stream (2E) from the clarifier (2) is dosed in-line (3) with an amount of a first hydroxide salt (3F). The first hydroxide salt can be any hydroxide salt suitable to react with dissolved metal ions on the leachate and form solids comprising the metal ions. Exemplary hydroxide salts include, but are not limited to, sodium, calcium, potassium, lithium, magnesium, or combinations thereof. In certain embodiments, the first hydroxide salt is not an alkali metal salt, and in particular embodiments, the first hydroxide salt is a calcium salt, such as lime soda (Ca(OH)₂). Without being bound to a particular theory, in some embodiments, the first hydroxide salt may be selected such that it is not fully soluble in the leachate, (that is the hydroxide salt may be sparingly soluble in water) and thus the metal precipitate (solids formed from the hydroxide and metal ions) is formed substantially directly from the first hydroxide solids and/or the small amount of the first hydroxide salt that does dissolve. For example, lime soda may be used because calcium hydroxide remains substantially as a solid due to its low solubility in water, while still reacting with dissolved metal ions in the liquid stream, which can be demonstrated by elemental analysis of the metals solids, such as by Inductively Coupled Plasma Optical Emission Spectroscopy, (ICP-OES). In some embodiments, the amount of hydroxide added with each addition is from 3 grams to 10 grams or more per gallon of liquid to be treated. The hydroxide salt solids form a liquid slurry of metal solids (3H) in the piping and is separated in the clarifier (4).

Metal²⁺Ca(OH)_{2(S)}+Metal(OH)_{2(S)}+CA²⁺ Equation 3

The liquid effluent stream (2E) may be in a pipe selected to facilitate turbulent flow (Reynolds number Re >4,000) and adequate mixing of the first hydroxide salt and effluent stream. After mixing, the pipe diameter may be increased and/or the number of pipes increased to produce a decreased Reynolds number for the liquid stream of from 10 to 2,000 (laminar flow range) and facilitate the floc formation and coagulation. The sizing of the pipes will be dependent on the volume of the landfill leachate to be treated but in general will consist of pipe diameters in the range of 1-18″ and number of such pipes (1-100) could be used to treat various volumes of leachate (0-128 million gal/year). The residence times in the pipes after mixing is dependent on the leachate characteristics will be in the range of 1-60 min. The pipe lengths will be chosen to ensure adequate residence times to allow adequate separation of the coagulated flocs. Table 1 provides exemplary wastewater feed pipe dimensions calculated using the Reynold's equation (Equation 2) and an estimated annual volume of wastewater generated from rainfall.

TABLE 1
Exemplary wastewater feed pipe dimensions at various wastewater volumes.

| Volume | Volumetric | | | | | Dynamic |
|---|---|---|---|---|---|---|
| wastewater | flow rate | Velocity | D_{H} = dₚᵢₚₑ | D_{H} = dₚᵢₚₑ | Density ρ | viscosity η |
| (MGPY) | (gal s⁻¹) | u (m s⁻¹) | (m) | (in) | (kg m⁻³) | (kg m⁻¹ s⁻¹) |
| 1 | 0.033 | 0.325 | 0.022 | 0.87 | 989 | 0.00089 |
| 2 | 0.066 | 0.162 | 0.044 | 1.74 | | |
| 4 | 0.132 | 0.0812 | 0.089 | 3.49 | | |
| 8 | 0.265 | 0.0406 | 0.177 | 6.97 | | |
| 16 | 0.529 | 0.0203 | 0.354 | 13.95 | | |
| 32 | 1.058 | 0.0102 | 0.708 | 27.89 | | |
| 64 | 2.116 | 0.0051 | 1.417 | 55.79 | | |
| 128 | 4.233 | 0.0025 | 2.834 | 111.57 | | |

MGPY = Million gallons per year

Dynamic viscosity is assumed to be that of water

$${D}_{H} = \frac{4 \times area}{wetted perimiter} = \frac{4 {π ( d / 2 )}^{2}}{2 π ( d / 2 )} = d \qquad Equation 4$$

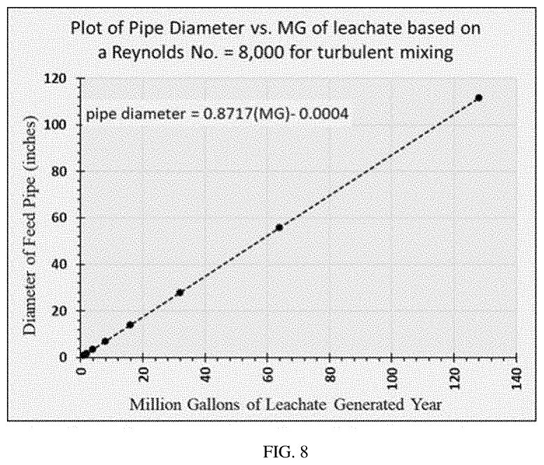

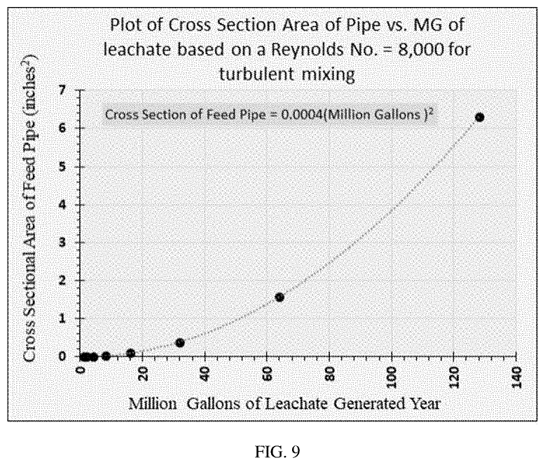

FIG. 8 illustrates the effect of leachate volume and the diameter of the pipe. However, in some circumstances it may be difficult to operate fluid flow in a 110 inch pipe. Therefore, the cross-sectional area of the pipe may be used, where the total cross-sectional area is divided by the cross-sectional area of a 12 inch or 24 inch pipe. This also may help determine the number of solid/liquid separators to use. The cross-sectional area of the pipe may be more useful for designing the feed pipe. As wastewater volume increases, the feed may be divided into parallel piping and then may be directed into separate solid/liquid separators. In some embodiments, the pipe diameter is from greater than zero to 18 inches, such as from 12 to 18 inches (FIG. 9).

Again with respect to FIGS. 1 and 2, the solids are recovered from a clarifier (4) where the solid fraction (4K), rich in metal ions, such as ferric iron, Fe³⁺, is recycled back to the coagulant tank (1B) and reused in the organic-complexation (1), as demonstrated by Equation 5.

m(fatty acids)+Mⁿ⁺(OH⁻)ₙ→(fatty acid)ₘMⁿ⁺(OH⁻)ₙ Equation 5

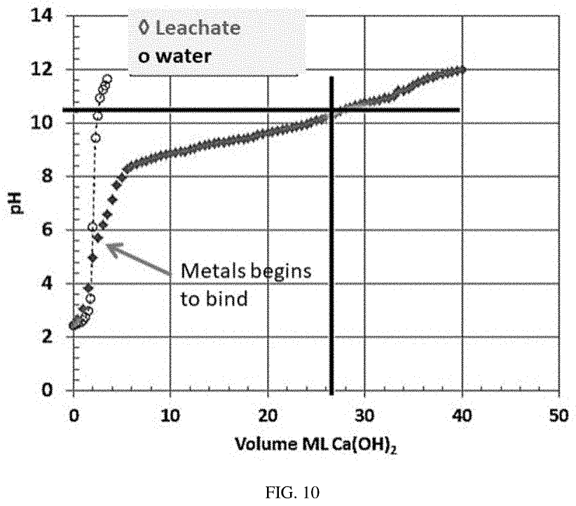

The liquid effluent stream (4J) from the clarifier (4) is dosed in-line (5) with a measured amount of a second hydroxide salt (5L) that forms a slurry of solids (5M). The liquid effluent stream (4J) may be in a pipe having a diameter and/or length selected to facilitate turbulent flow and adequate mixing of the first hydroxide salt and effluent stream. After mixing, the pipe diameter may be increased to facilitate laminar flow and to allow the coagulated matter solids to increase in size. The second hydroxide salt may be the same or different as the first hydroxide salt, and/or the amount of the second hydroxide salt may be the same or different from the amount of the first hydroxide salt. The amount of the first, second and any subsequent hydroxide salt additions may depend on a desired pH and/or the amount of metals remaining in the effluent stream. In some embodiments, the first, second and any subsequent amounts of the hydroxide salt(s) can be determined by monitoring the pH of the liquid stream. For example, if no metals are present, the addition of a hydroxide salt will result in a large increase in pH, such as to 10 or more (FIG. 10). However, if metals are present, the pH will only increase slowly as hydroxide ions that are added by the addition of the hydroxide are removed from the solution as insoluble metal salts (FIG. 10).

Referring again to FIGS. 1 and 2, the solids (5M) are recovered from the clarifier (6), where the solids (6P) are dried and stored in containers (6PS). The liquid stream (6N) from clarifier (6) may be dosed in-line (7) with an amount of a third hydroxide salt, which may be the same or different from either the first or second hydroxide salts, (7Q) that quickly forms a slurry of solids in the effluent stream (7R). The liquid effluent stream (6N) may be in a pipe having a diameter and/or length selected to facilitate turbulent flow and adequate mixing of the first hydroxide salt and effluent stream. After mixing, the pipe diameter may be increased to facilitate laminar flow and to allow the coagulated matter solids to increase in size. Clarifier (8) separates the solids (8T) from the liquid (8S). Solids (8T) may be dried and stored in containers (8TS). In certain embodiments, the first, second, and third hydroxide salts each are calcium hydroxide. And in some embodiments, one or more additional amounts of hydroxide salts may be added. Different metal compositions can be sequentially separated based on separate hydroxide salt additions (3, 5, 7), such as by recovering the solids formed at different pHs. For example, in some embodiments, solids are recovered at a pH of up to 9, from 9 to 10, and/or 10 and above, such as from 7 to less than 9, from 9 to 10, and/or from greater than 10 to 12, or at about pH 8.5, 9.5 and 10.3. And in some embodiments, the solids comprise ferric salts, transition metal salts and rare earth salts, respectively. Depending on the composition of the LL, this sequential process in the metals recovery module can occur at least once or be repeated any number of sequential times as warranted, such as 2, 3, 4, 5 or more times.

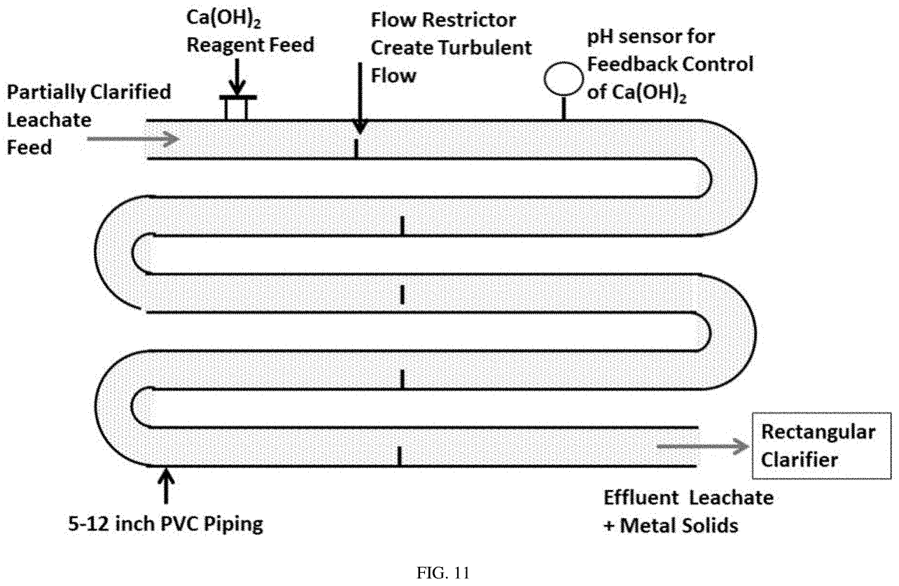

By extensive sampling, the optimal pH for the formation of a specific class of metal precipitate can be determined. In one exemplary embodiment, the system is automated to control and allow for the incremental addition of the hydroxide salt(s), such as Ca(OH)₂, and separation of metals (FIG. 11). These solids may be separated into different holding tanks for further processing. This may comprise dissolving the metal hydroxides with acid then precipitating with different salts, such as carbonate or sulfides. Ferric fractions can be separated, such as by applying a magnetic force to the dry metal hydroxides and can be then recycled back into the step (1) for organic compound particle formation as described above.

C. Ammonia Recovery

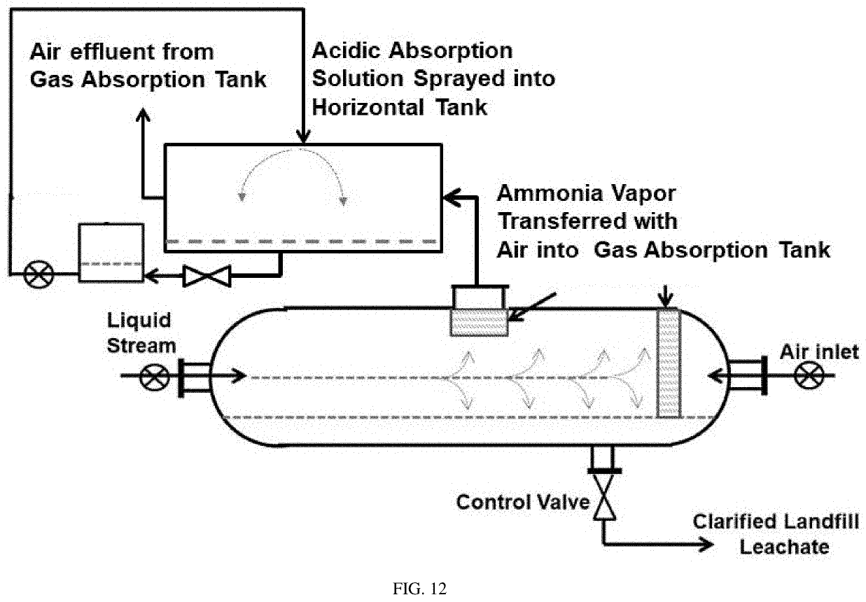

With respect to FIGS. 1 and 2, the liquid fraction (8S) from the clarifier (8) is then formed into droplets, such as by being pumped through a number of spray nozzles into a flash drum (9) (one example configuration is illustrated in FIG. 12). A countercurrent air flow (10U) may be generated from a centrifugal blower (10) that moves the ammonia vapor (9V) out of the flash vessel into an attached ammonia scrubber (11), such as by using a flow of clean, substantially ammonia-free, air. In one embodiment, the system uses a high-pressure feed into a specifically designed spray nozzle that reduces the droplet diameter such that the available surface area for gas exchange with the air is significantly increased so that the gaseous diffusion of ammonia is not a limiting factor. In some embodiments the droplet size is sufficient such that at least 50% of the ammonia present in the liquid is removed, such as at least 60%, 70%, 80%, 90%, 95% or more than 95% of the ammonia is removed.

The droplets may be formed by exerting a pressure differential across the opening of a spray nozzle, as it is sprayed into a vessel. The vessel may be a single-stage flash vessel fluidly connected to clarifier (8) to receive the liquid fraction (8S), and may comprise a pump to spray liquid fraction (8S) into the vessel. The vessel may have sufficient volume to allow maximum flight of the droplets to facilitate reaching equilibrium with the ammonia in the droplets and the concentration of the ammonia vapor on the surface of the droplets. Without being bound to a particular theory, the ammonium may be converted to ammonia due to a change in pH. And ammonia may be removed due to the low solubility of the ammonia vapor in the liquid and/or the high surface area generated by the large number of small droplets.

The droplets may be exposed to clean air being brought into the vessel, and because ammonia is being removed in the vessel, the system is not able to reach equilibrium. Therefore, the amount of ammonia removed may be dependent on the droplet diameter and/or the velocity of the clean air across the surface of the droplet.

In some embodiments, the pressure is selected to provide droplets having a diameter of from 10 micrometers or less to 1000 micrometers or more, such as from 10 micrometers to 500 micrometers, or from 50 micrometers to 100 micrometers. In some embodiments, the pressure is from 100 psi or less to 300 psi or more, such as from 100 psi to 150 psi, and in certain working embodiments, the pressure is about 120 psi. Single or multiple spray nozzles may be used continuously in the drum. The ammonia may be recovered in a form of ammonium salt (11ZS), such as ammonium sulfate, using a diluted acid solution (11X), such as sulfuric acid. The resultant ammonium salt is dried and stored. The water (9W) from the flash drum (9) can be discharged onto land surface and/or constructed wetland. In certain examples, the liquid is discharged onto an engineered orchard of plants for phytoremediation, such as, but not limited to, poplar trees.

The pH of the scrubbing solution (11X) is controlled by a pH sensor that maintains the scrubbing solution at a pH of from 3 to 4. The scrubbing solution is cycled through the ammonia scrubber until the concentration of ammonia reaches 50% to 75% or more saturation. This solution is then dried, collected, and stored as an ammonium salt, such as ammonium sulfate (11ZS).

In an alternative embodiment, the disclosed system and method can by-pass the organic recovery and directly recover ammonia from the wastewater, such as landfill leachate, by flashing the raw wastewater directly (12BB and 12). The process recovers both the metals and ammonia in a single process step. Alternatively, if the ammonia is low (<150 mg NH₃/L_{leachate}), the ammonia recovery step can be by-passed and only the metals and organics are recovered. Ammonia in the resulting treated water stream can optionally be treated using known methods, such as biological nitrification-denitrification processes.

The system and method recycle the acidified-liquid gas absorber through the packed bed, such as in the form of a mist, until at least 50% saturation, more preferably 75% saturation or more. This solution is then passed through a spray-drying tower where the ammonium salts are collected. The clarified water from the flash drum is suitable for an agricultural application. The liquid effluent from the flash drum meets the required specifications for ammonia, metals, and COD/BOD₅ to be discharged onto an engineered wetland for tertiary treatment. The tertiary treatment may be a final aerobic degradation step utilizing the native microbial populations that degrade recalcitrant compounds. In some embodiments, the required specifications, for example, for surface water discharge, include ammonia monthly average <5 mg/L, COD/BOD5 monthly average <5, a COD monthly average <50 mg/L, and/or metal monthly average <200 ppb. The required specifications for a land application may be similar but may depend on the soil texture, fraction of soil organic matter, and/or plant and microbial biota.

### IV. Examples

### Example 1

The objective of this experiment was to determine the optimal pH for the formation and removal of organic matter from the LL at a constant concentration of FeCl₃. 500 mg/L FeCl₃ stock solution was used in these experiments. Each tube was filled with 45 mL of leachate and the pH was adjusted to the appropriate pH, then the volume was adjusted to 50 mL. The FeCl₃ solution was added in 0.5 mL increments.

TABLE 2
Raw leachate

| pH | tare(mg) | gross(mg) | net dry sludge(mg) |
|---|---|---|---|
| 8.5 | 14.5009 | 14.5358 | 0.0349 |
| 7 | 14.5355 | 14.5786 | 0.0431 |
| 6 | 13.9666 | 14.0184 | 0.0518 |
| 5 | 14.5669 | 14.623 | 0.0561 |
| 4 | 14.4179 | 14.8229 | 0.405 |
| 3 | 13.7663 | 14.4628 | 0.6965 |

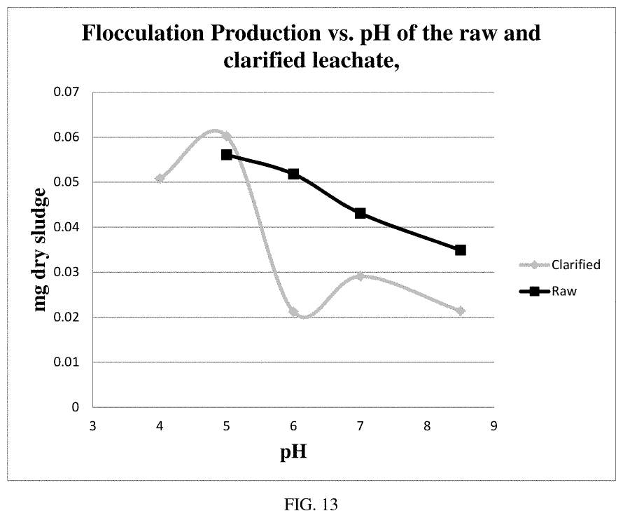

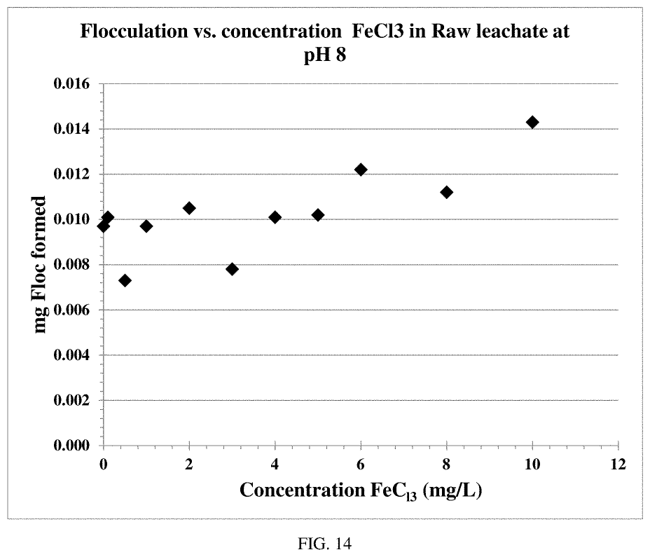

The results shown in Table 2 and FIG. 13, show that addition of FeCl₃ at low pH results in more residue being removed from the leachate than that obtained at higher pHs. And FIG. 14 illustrates the effect of adding various amounts of ferric chloride to the leachate at pH 8.

### Example 2

### pH Optimization of Flocculation of Landfill Leachate Using Ferric Chloride

The raw landfill leachate collected directly from the landfill contains a small amount of fixed solids, such as soil particles, small particle from the MSW, and contaminants that have overtime precipitated out of solution. This experiment was to determine if the clarification of the raw leachate enhances the formation of floc and reduction of chemical oxygen demand (COD).

A 500 mg/L FeCl₃ stock solution was used. Two sets of tubes were prepared with each tube being filled with 45 mL of leachate and the pH was adjusted to the appropriate pH. Then one set of tubes were centrifuged at 1500 g for 5 minutes to remove any fixed solids. The volume was adjusted to 50 mL and 0.5 mL was removed and 0.5 mL of the FeCl₃ solution was added to each tube.

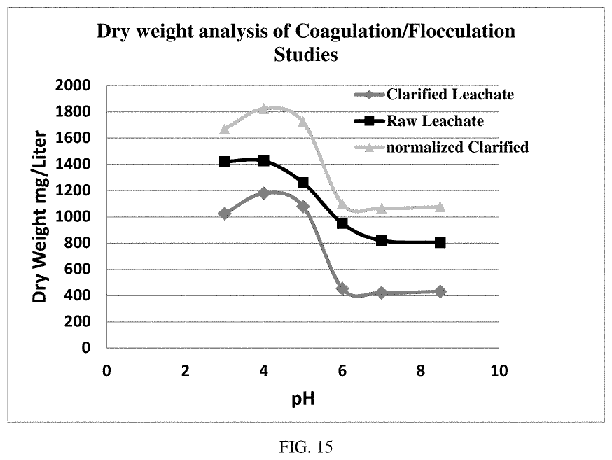

Table 3 provides the amounts of residue that was removed from the leachate at various pHs after some impurities had been precipitated out and separated from the leachate before the addition of either the iron salt or the hydroxide salt. And FIG. 15 illustrates that the amount of solids removed and how COD was enhanced by performing an initial clarification of the leachate, and that pHs of about 4-5 provided optimal coagulation.

TABLE 3
Clarified leachate

| pH | tare(mg) | gross(mg) | net dry sludge(mg) |
|---|---|---|---|
| 8.5 | 13.7807 | 13.8021 | 0.0214 |
| 7 | 13.614 | 13.6431 | 0.0291 |
| 6 | 13.7041 | 13.7253 | 0.0212 |
| 5 | 13.9053 | 13.9655 | 0.0602 |
| 4 | 13.8644 | 13.9152 | 0.0508 |

### Example 3

A pilot plant according to the system disclosed herein was used to process 500 gallons of leachate in a continuous run. The pilot plant was a fully automated system controlled by a commercially available programmable microcontroller. The results provided by Table 4 illustrate the reproducibility and robustness of the process, and that the overall removal of solids from the raw leachate was >95%. The identifiers in the Sample Description column of Table 4 refer to elements in FIGS. 1 and 2.

TABLE 4
Results from a 500-gallon pilot plant run

| Sample | TS | TSS | TVS | NH₃—N |
|---|---|---|---|---|
| Description | (mg/L) | (mg/L | (mg/L) | (mg/L |
| Raw Leachate | 11.313 | 2.943 | 8.370 | 982 |
| Liquid 2E | 6.108 | 1.469 | 4.639 | 897 |
| Liquid 4J | 4.579 | 1.191 | 3.388 | 902 |
| Liquid 6N | 3.217 | 0.859 | 2.358 | 954 |
| Liquid 8S | 0.45 | 0.115 | 0.335 | 837 |
| Liquid 9W | 0.409 | 0.297 | 0.112 | 93.2 |
| Percent removed | 96.4% | 89.9% | 98.7% | 90.5% |

With respect to Table 4, TS is the total solids obtained by taking a volume of the leachate, placing into a pre-weighed crucible, and drying at 105° C. for 1-2 hours or until the dry weight remains constant. The total solids is the amount of dry solid material remaining in the crucible. TTS is the total suspended solids obtained by filtering the leachate through a Whatman™ 934-AH™ Glass Microfiber filter per EPA ESS Method 340.2. A known volume of the filtrate is placed in a pre-weighed crucible (tare weight) and dry at 105° C. until the weight is constant. This dry weight is subtracted from the tare weight to give the TSS in mg per liter. Then the same crucible is placed in an incinerator set at 500° C. for a period of time until the weight is constant. This weight is subtracted from the TSS value to provide the weight of volatiles (total volatile solids—TVS). The remaining solids in the crucible is primarily ash.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, comprising:
combining wastewater and a coagulant to form a first mixture comprising a first solid formed from the coagulant and organic matter present in the wastewater;
separating the first solid from the first mixture to form a first liquid;
combining the first liquid with one or more hydroxide salts to form a second mixture comprising a second solid formed from the one or more hydroxide salts and dissolved metal ions;
separating the second solid from the second mixture to form a second liquid; and
forming droplets from the second liquid and exposing the droplets to an air flow sufficient to remove at least a portion of ammonia present in the droplets.

2. The method of claim 1, where in the coagulant comprises an organic salt, an inorganic salt, or a combination thereof.

3. The method of claim 2, wherein the coagulant is an iron salt.

4. The method of claim 3, wherein the iron salt is ferric chloride.

5. The method of claim 1, wherein combining the first liquid with the one or more hydroxide salt to form the second mixture and separating the second mixture to form the second liquid comprises:
combining the first liquid with an amount of a first hydroxide salt to form first intermediate mixture comprising a first intermediate solid;
separating the first intermediate solid from the first intermediate mixture to form a first intermediate liquid;
adding an amount of a second hydroxide salt to the first intermediate liquid to form a second intermediate mixture comprising a second intermediate solid;
separating the second intermediate solid from the second intermediate mixture to form a second intermediate liquid;
adding an amount of a third hydroxide salt to the second intermediate liquid to form a third intermediate mixture comprising a third intermediate solid; and
separating the third intermediate solid from the third intermediate mixture to form the second liquid.

6. The method of claim 5, wherein:
the amount of the first hydroxide salt is selected to provide a pH for the first intermediate mixture of 8.5 or less;
the amount of the second hydroxide salt is selected to provide a pH for the second intermediate mixture of 9.5 or less;
the amount of the third hydroxide salt is selected to provide a pH for the third intermediate mixture of 10.3 or less; or
a combination thereof.

7. The method of claim 5, wherein the first hydroxide salt, the second hydroxide salt and the third hydroxide salt are the same.

8. The method of claim 1, wherein the one or more hydroxide salts comprises calcium hydroxide.

9. The method of claim 1, wherein forming the droplets comprises flowing the second liquid through a nozzle at a pressure suitable to form the droplets.

10. The method of claim 9, wherein:
the pressure is from 100 psi to 300 psi;
the droplets have a droplet size of from 10 micrometers to 1,000 micrometers; or
a combination thereof.

11. The method of claim 1, wherein:
the coagulant is added to the wastewater in an amount sufficient to remove at least 90% of any acidic organic matter present in the wastewater;
the hydroxide salt is added to the first liquid in an amount sufficient to remove at least 90% of any metal ion impurities present in the first liquid;
forming the droplets and exposing them to the air flow removes at least 90% of any ammonia present in the second liquid; or
a combination thereof.

12. The method of claim 1, further comprising collecting the droplets after exposure to the air flow to form a treated water stream suitable for discharge or further water treatment processing.

13. The method of claim 1, further comprising collecting the removed ammonia with an acidic scrubbing solution.

14. The method of claim 13, wherein the acidic scrubbing solution is recycled and reused until a concentration of ammonium in the acidic scrubbing solution is above 50% saturation.

15. The method of claim 13, further comprising drying the acidic scrubbing solution to form an ammonium salt.

16. A system, comprising a wastewater pathway, comprising:
a wastewater inlet;
an organics separator module;
a metal recovery module; and
an ammonia recovery module.

17. The system of claim 16, wherein the organics separator module comprises:
a coagulant inlet downstream from the wastewater inlet;
a reactor downstream of the coagulant inlet; and
a first separator downstream of the reactor, the first separator comprising a first solids outlet and a first liquid outlet.

18. The system of claim 17, wherein the metal recovery module comprises:
a first water flow pathway fluidly coupled to the first liquid outlet and comprising a first hydroxide salt inlet;
a second separator fluidly coupled to the first water flow pathway downstream from the first hydroxide salt inlet, the second separator comprising a second solids outlet and a second liquid outlet;
a second water flow pathway fluidly coupled to the second liquid outlet and comprising a second hydroxide salt inlet;
a third separator fluidly coupled to the second water flow pathway downstream from the second hydroxide salt inlet, the third separator comprising a third solids outlet and a third liquid outlet;
a third water flow pathway fluidly coupled to the third liquid outlet and comprising a third hydroxide salt inlet; and
a fourth separator fluidly coupled to the third water flow pathway downstream from the third hydroxide salt inlet, the fourth separator comprising a fourth solids outlet and a fourth liquid outlet.

19. The system of claim 18, wherein the ammonia recovery module comprises:
an ammonia separator fluidly coupled to the fourth liquid outlet, the ammonia separator comprising at least one nozzle that forms droplets from a fluid stream received from the fourth liquid outlet; and
a blower configured to produce an air flow counter to a direction of motion of the droplets formed by the nozzle.

20. The system of claim 18, wherein the first separator, the second separator, the third separator and/or the fourth separator independently is a clarifier.

21. The system of claim 18, wherein the first separator, the second separator, the third separator and/or the fourth separator independently is selected from a baffled rectangular clarifier, a circular-lamella clarifier, or a plate and frame filter press.

22. The system of claim 19, wherein the system further comprises an ammonia scrubber fluidly coupled to the ammonia separator.
